(19) United States
(12) Patent Application Publication
(10) Pub. No.: US 2017/0170438 A1
(43) Pub. Date: Jun. 15, 2017

(54) BATTERY PACKAGING SYSTEM AND METHOD FOR A VEHICLE

(71) Applicant: General Electric Company, Schenectady, NY (US)

(72) Inventors: PATRICK LEE JANSEN, Scotia, NY (US); Neil William Burkell, Erie, PA (US); Neil Patrick Bradley, Erie, PA (US); Mark Alan Pfingsten, Elyria, OH (US)

(73) Assignee: General Electric Company, Schenectady, NY (US)

(21) Appl. No.: 14/967,737

(22) Filed: Dec. 14, 2015

(51) Int. Cl. H01M 2/10; H01M 10/0525; H01M 2/30; H01M 2/20; B60K 1/04; B60L 11/18

(52) U.S. Cl. CPC H01M 2/1077; B60K 1/04; B60L 11/1877; B60L 11/1879; H01M 2/1083; H01M 2/305; H01M 2/206; H01M 10/0525; B60K 2001/0416; B60Y 2200/20; B60Y 2200/91; B60Y 2306/01; H01M 2220/20

(57) ABSTRACT

A system for a vehicle includes a housing connected to the vehicle, the housing having a bottom floor, a plurality of exterior walls, at least one partition wall within the housing diving the housing into a plurality of sections, and a plurality of battery modules arranged in a vertical orientation within the housing.

### BACKGROUND

Technical Field

Embodiments of the invention relate generally to energy storage systems for vehicles. Certain embodiments relate to a battery packaging system and method for an underground mining vehicle.

Discussion of Art

Large format battery packs have been utilized in mobile applications such as automobiles for quite some time. These battery packs are typically designed to have low profiles to meet available space limitations and low center-of-gravity requirements.

Vehicles for underground mining operations, such as scoops, load-haul-dump vehicles (“LHDs”), and haul trucks may also be powered by large batteries carried on the vehicles. These batteries allow the vehicle to travel without cables throughout a mine for a limited period of time. Battery packing systems for underground mining vehicles, however, require many different considerations due to the unique environment in which such vehicles operate. In particular, battery packs for underground mining vehicles must be designed for rapid installation and/or replacement of individual battery modules. Furthermore, they must be designed to operate reliably in the rugged environments experienced by these vehicles in underground mines, especially extreme repetitive shock, excessive rock, dirt and debris, and overall abuse. As a result, battery modules and packages utilized in other industries are, on the whole, simply not suitable for use in underground mining vehicles.

In view of the above, there is a need for a battery packaging system and method for use, specifically, in underground mining vehicles that is robust enough to withstand the demanding environment within which such vehicles operate.

### BRIEF DESCRIPTION

In an embodiment, a system (e.g., a battery packaging system) for a vehicle includes a housing connected to the vehicle, the housing having a bottom floor and a plurality of exterior walls. The system further includes at least one partition wall within the housing dividing the housing into a plurality of sections, and a plurality of battery modules arranged in a vertical orientation within the housing.

In an embodiment, a method for installing a battery module in a vehicle includes the steps of lowering the battery module into a tray of the vehicle, the tray having at least one partition wall dividing the tray into a plurality of sections and a plurality of locating pins extending upwardly from a bottom of the tray, receiving one of the locating pins in a socket formed on the bottom of the battery module, and mounting an upper end of the battery module to the at least one partition wall.

In an embodiment, an underground mining vehicle includes a front section having a scoop or other work member, a rear section having a battery packaging assembly for providing electrical power to the vehicle, and an articulated joint between the front section and the rear section. The battery packaging assembly includes a housing having a bottom floor, a plurality of exterior walls, at least one partition wall within the housing dividing the housing into a plurality of sections, and a plurality of battery modules arranged in a vertical orientation within the housing.

### DRAWINGS

The present invention will be better understood from reading the following description of non-limiting embodiments, with reference to the attached drawings, wherein below:

FIGS. 1A-1E are various views of embodiments of vehicles on which battery packaging systems according to embodiments of the invention are utilized.

FIG. 2 is a perspective view of a battery packaging system according to an embodiment of the invention.

FIG. 3 is a top plan view of the battery packaging system of FIG. 2.

FIG. 4 is a perspective view of the battery packaging system of FIG. 2, illustrating installation (or removal) of a single battery module.

FIG. 5 is a cross-sectional, perspective view of the battery packaging system of FIG. 2.

FIG. 6 is a side, cross-sectional view of the battery packaging system of FIG. 2.

FIG. 7 is a perspective view illustrating two different sized battery modules of the battery packaging system, according to an embodiment of the invention.

FIG. 8 is an exploded, perspective view of a socket mount at the bottom of the battery module.

FIG. 9 is a perspective view of the socket mount at the bottom of the battery module, shown in assembled state.

FIG. 10 is a detail, cross-sectional, side view of the battery packaging system of FIG. 2, showing installation of a battery module.

FIG. 11 is a detail, cross-sectional, side view of the battery packaging system of FIG. 2, showing a battery module in assembled position.

FIG. 12 is a detail, cross-sectional side view of the battery packaging system of FIG. 2, showing the mounting arrangement of opposing battery modules.

FIG. 13 is a detail, top plan view of the battery packaging system of FIG. 2, showing the mounting arrangement of opposing battery modules.

FIG. 14 is a detail, perspective view of the battery packaging system of FIG. 2, showing the mounting arrangement of opposing battery modules.

FIG. 15-18 are various views illustrating the mounting of battery modules.

FIG. 19 is a perspective view of a battery packaging system according to another embodiment of the present invention.

FIG. 20 is a cross-sectional, perspective view of the battery packaging system of FIG. 19.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts. Although exemplary embodiments of the present invention are described with respect to underground mining vehicles and, in particular, to load-haul-dump vehicles, embodiments of the invention may also be applicable for use with vehicles and machinery, generally. In particular, aspects of the invention may also be applicable to other industrial or commercial vehicles, such as haul trucks and off-highway vehicle (OHVs), or in other applications where space for battery packaging is limited but where quick and easy replacement of batteries is desired.

As used herein, “electrical contact,” “electrical communication” and “electrically coupled” means that the referenced elements are directly or indirectly connected such that an electrical current may flow from one to the other. The connection may include a direct conductive connection (i.e., without an intervening capacitive, inductive or active element), an inductive connection, a capacitive connection, and/or any other suitable electrical connection. Intervening components may be present.

For clarification purposes within this document, a battery pack is defined to consist of one or more battery modules electrically connected in a series, parallel and/or combination series-parallel manner. Each battery module consists of a multitude of rechargeable battery cells, wherein the battery cells are electrochemical units having a positive terminal, or cathode, and a negative terminal, or anode.

Embodiments of the invention relate to a battery packaging system. Battery modules including battery cells, such as lithium-ion cells, are contained and interconnected within a rigid metallic enclosure, referred to as a tray, in a stacked manner forming an assembly that has a long rectangular shape. The modules are mounted in a vertical orientation in a single layer. The mounting means includes bolted isolators at the top of the modules which are readily accessible from the top of the tray. A pin and socket type mounting means is located at the module and the tray, where access is extremely limited. Both the bolted mounts at the top, and the pin and socket type mounts at the bottom may include elastomeric isolation elements to provide shock and vibration isolation.

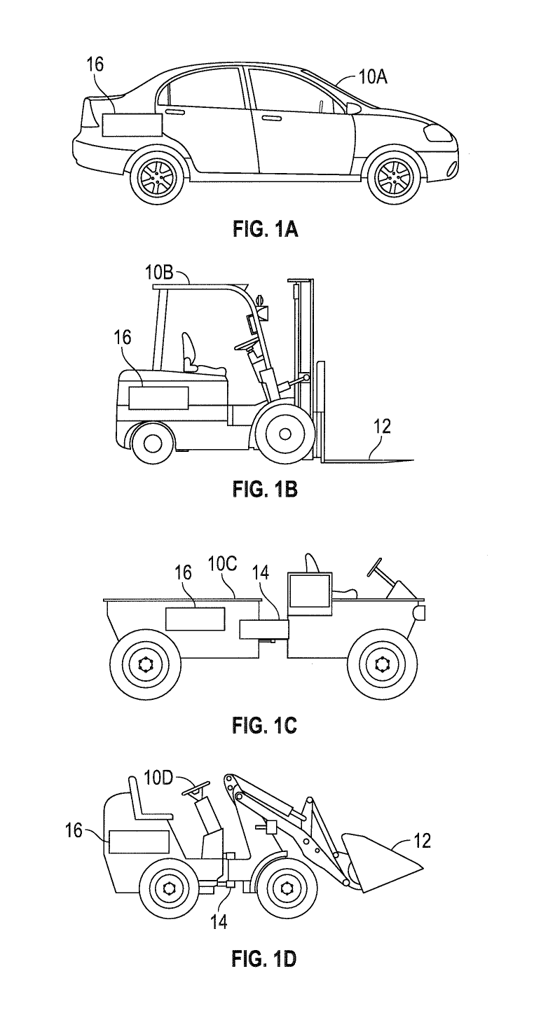

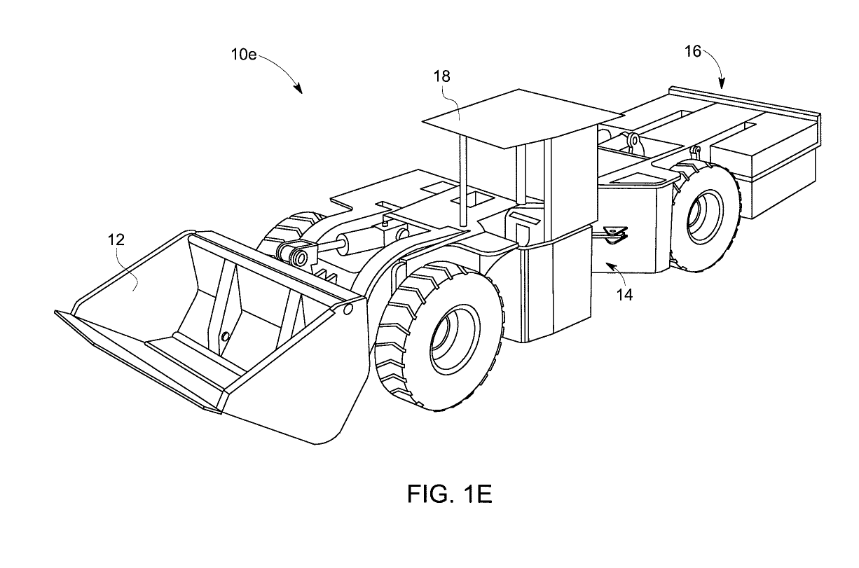

FIGS. 1A-1E show various embodiments of vehicles 10a-10e, respectively. In FIG. 1A, a vehicle 10a includes a chassis and a battery packaging system 16, which may be located at a rear of the vehicle or otherwise. In FIG. 1B, a vehicle 10b additionally includes a work member 12, which is a device configured for carrying out a work task of the vehicle. Examples include scoops, buckets, platform in lifts, fork lifts, drills, backhoes/hoes, shield haulers, etc. The work member may be disposed at a front end of the vehicle. In FIG. 1C, a vehicle 10c alternatively includes an articulated joint 14 at a middle of the vehicle, for steering. That is, the vehicle may include front and rear sections, each with at least one respective set of wheels, which are connected to one another for movement with the articulated joint. In FIG. 1D, a vehicle 10d includes both a work member 12 and an articulated joint 14. FIG. 1E shows one particular example of a vehicle 10e having the configuration of the vehicle 10d in FIG. 1D. Specifically, the vehicle 10e is a load-haul-dump vehicle for underground hardrock mining. The vehicle 10e includes a maneuverable scoop or bucket 12 at a front end thereof, an articulated joint 14 at the middle for steering, and a battery packaging system 16 at the rear.

As discussed in detail below, the battery packaging system 16 includes a plurality of battery modules providing an on-board power source for powering operations of the vehicle 10a-10e. Operations of the vehicle 10a-10e may include moving from location to location, loading mined material, and unloading mined material, as well as other operations typical of such vehicles. As illustrated in FIG. 1E (for example); the vehicle may include an operator compartment 18 within which a controller such as, for example, a joystick; console, interface, etc., allows an operator to control the vehicle. A computer (e.g., circuitry, microprocessor, or other hardware) may be mounted to or in communication with the controller and battery system packaging system 16. According to an exemplary embodiment, the controller is computerized such that operator commands are converted to an electrical signal, processed by the computer, and communicated to one or more electric motors and/or other components of the vehicle, such as hydraulic valves, linear actuators, and the like. Propulsion of the vehicle and hydraulic functions are achieved via one or more electric motors with power supplied by the battery system 16.

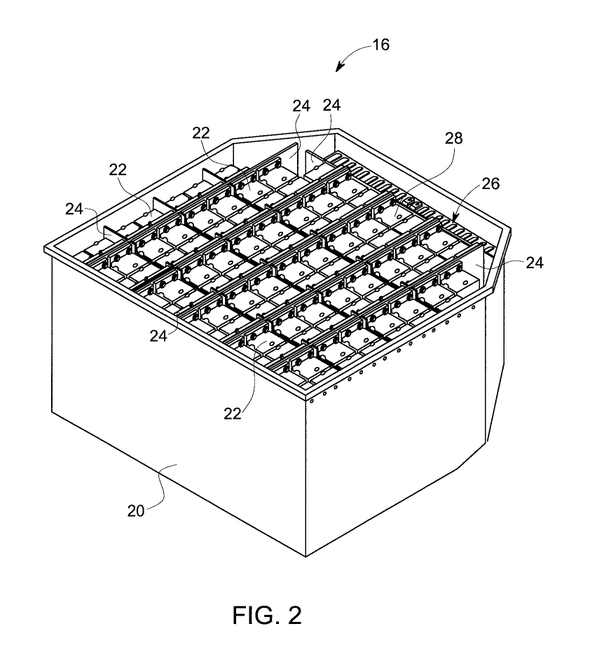

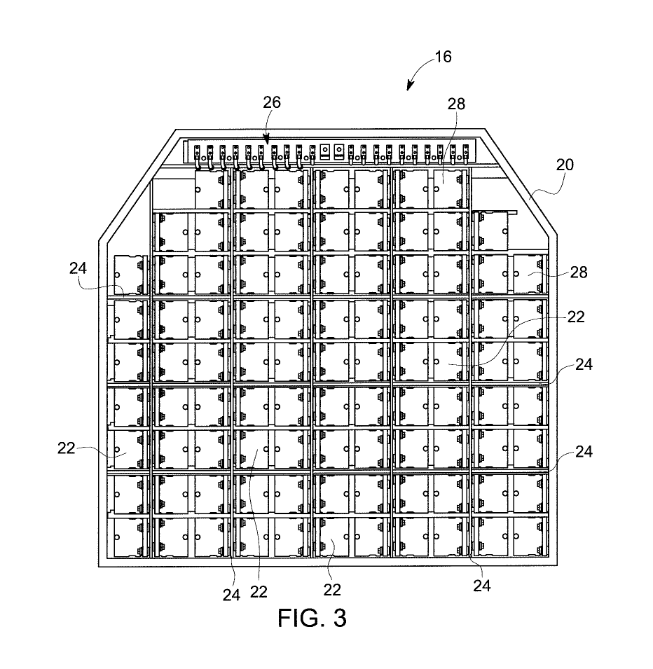

With reference to FIGS. 2 and 3, the battery packaging system 16 includes an enclosure or housing 20, also referred to as a tray, having an open top configured to receive covers (not shown) atop thereof, and a plurality of battery modules 22 mounted in vertical orientation therein, in a single layer. In an embodiment, the housing 20 may be generally rectangular in shape and is fabricated from welded steel. In an embodiment, the walls of the housing 20 are approximately 0.5 inches to 0.75 inches thick. Walls 24 forming interior partitions divide the housing 20 into sections. As illustrated, the housing 20 is configured to receive approximately 93 battery modules, although the housing may be configured to receive more or fewer than 93 battery modules depending on the specific power demands and operating range requirements of the vehicle 20. As also illustrated, the walls 24 are arranged such that each section within the housing 20 is configured to receive four modules, on average. In other embodiments, the size of the sections may vary, and the number of battery modules 22 per section can range from 1 to the total number of modules. In an embodiment, the sections are configured to accommodate approximately 2 to 10 battery modules per section to provide overall structural integrity. The battery modules 22 are rechargeable battery modules, such as lithium-ion (Li-ion) battery modules, although other rechargeable battery types may be utilized without departing from the broader aspects of the present invention.

In an embodiment, each battery module is elongate, that is, it has a height, defined by a longest axis of the module, that is greater than a width or length. The module may be vertically oriented when disposed in the housing, meaning the longest axis is generally perpendicular (plus or minus 10 degrees) to a ground surface on which the vehicle travels.”

As further illustrated in FIGS. 2 and 3, the housing 20 also houses a battery management system (“BMS”) 26 electrically connected to the battery modules. In certain embodiments, the BMS 26 may be located at various locations within the housing 20, including at the rear of the housing 20 as illustrated in FIGS. 2 and 3. Each module 22 includes power and sensing/control electrical terminals located at the top of each module 22. Power and sensing/control wiring (not shown) provides the electrical interconnection of the modules to form the desired series-parallel combination of strings and packs.

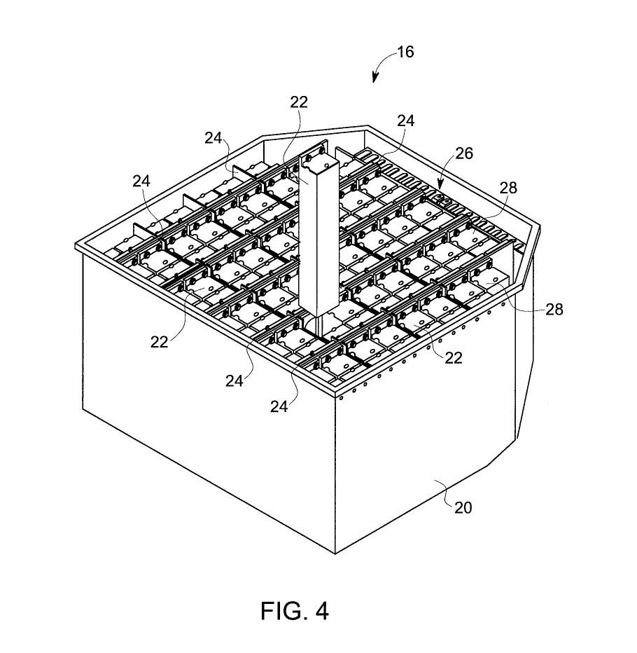

As illustrated in FIG. 4, and as discussed in detail below, individual battery modules 22 may be vertically installed into or removed from the sections in the housing 20 by lowering or lifting the module 22 from above, thereby facilitating rapid and efficient battery packaging system 16 assembly at the factory, as well as replacement of failed battery modules 22 at mine service shops.

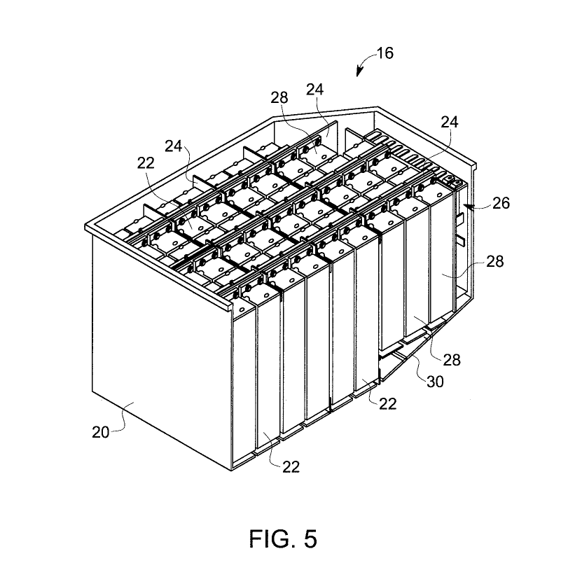

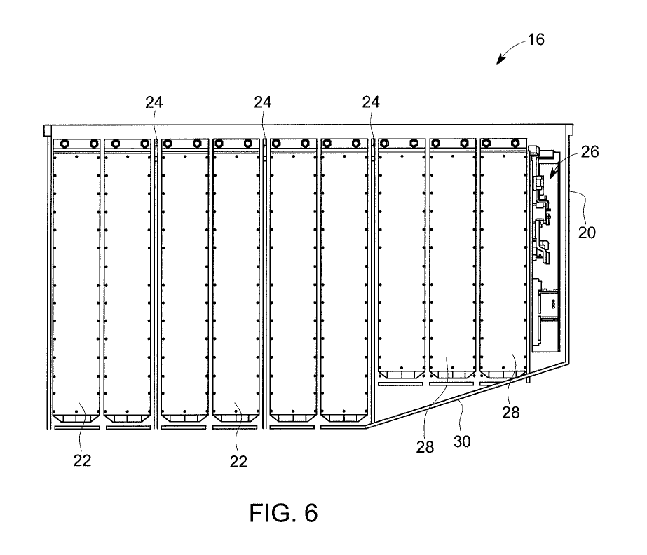

Referring now to FIGS. 5 and 6, in an embodiment, the housing 20, at its rear bottom, includes an angled bottom portion 30 that allows the vehicle 10a-10e to transition from a generally flat surface to an incline without scraping the housing 20 on the ground. The housing 20 is therefore configured to receive a plurality of different sized battery modules, including first battery modules 22 at the deepest, forward portion of the housing 20, and second battery modules 28 having a reduced height above the angled portion 30 (which limits the vertical space available within the housing). The embodiment illustrated in FIGS. 2-6 is configured to accommodate 66 tall battery modules 22 and 27 shorter battery modules 28.

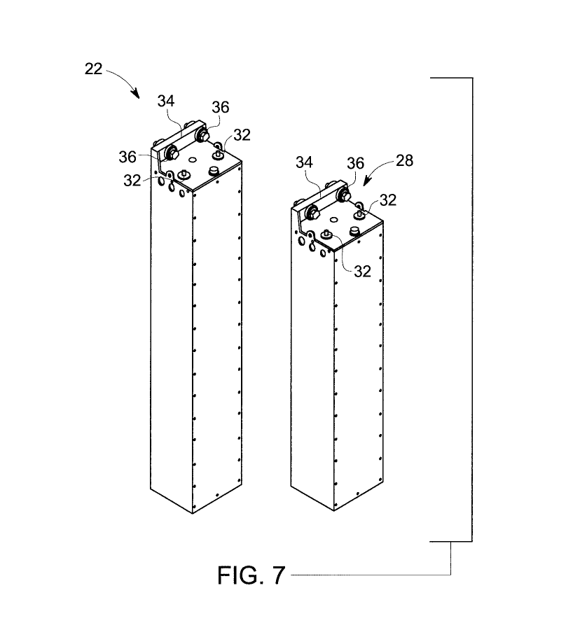

The first battery modules 22 and the second battery modules 28, having a reduced height, are best illustrated in FIG. 7. The electrical terminals 32 enabling interconnection among the modules 22, 28 and connection to the BMS 26 can be best seen therein. As also shown in FIG. 7, each module 22, 28 has an upstanding flange 34 having a pair of apertures therethrough, through which threaded bolts are received to enable secure mounting of the battery modules 22, 28 within the housing in the manner described hereinafter. In an embodiment, the housing of each battery module is of formed and welded sheet metal. In other embodiments, the housing can be molded or die-cast of metal such as aluminum or polymer composites such as bulk-molding compounds. As the electrical connections are located at the top of the module, they are readily accessible from the top of the housing 20 (upon removal of the covers), thereby allowing for fast and easy electrical connection and disconnection.

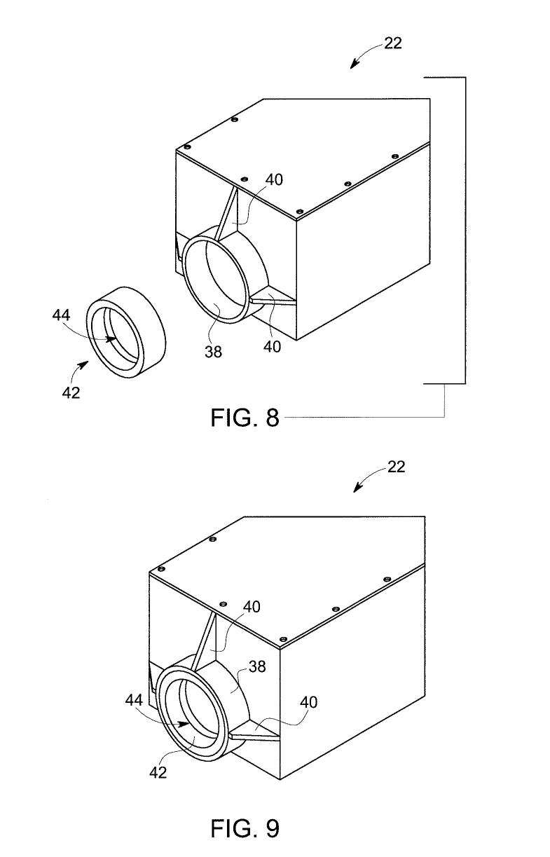

Turning now to FIGS. 8 and 9, the bottom of each battery module 22, 28 is provided with a socket mount 38 in the form of a steel ring that is welded or otherwise secured to the bottom surface of each module. In an embodiment, the socket mount 38 may be formed from other materials, such as molded composite materials. Reinforcement ribs 40 may be welded to the socket mount 38 and the module housing in order to increase structural rigidity. In other embodiments, one or more of the module housing, socket mount 38 and/or the ribs 40 may be formed as a single piece casting. An annular, elastomeric mounting isolator 42 may be received by the socket mount 38, defining a recess 44 therein.

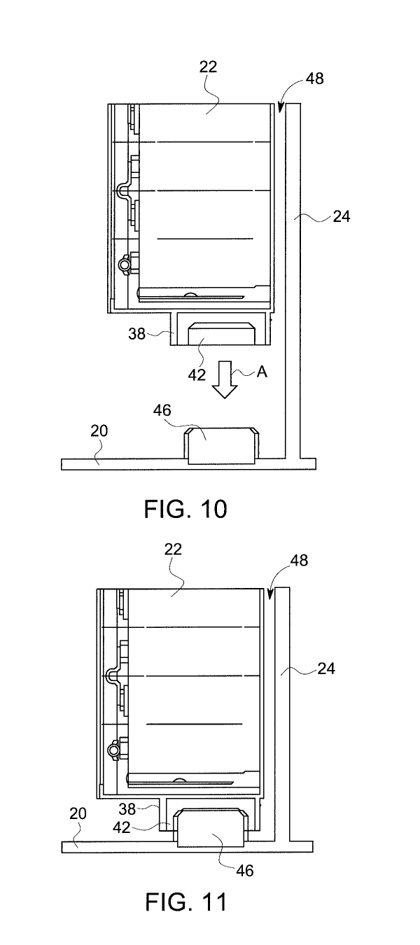

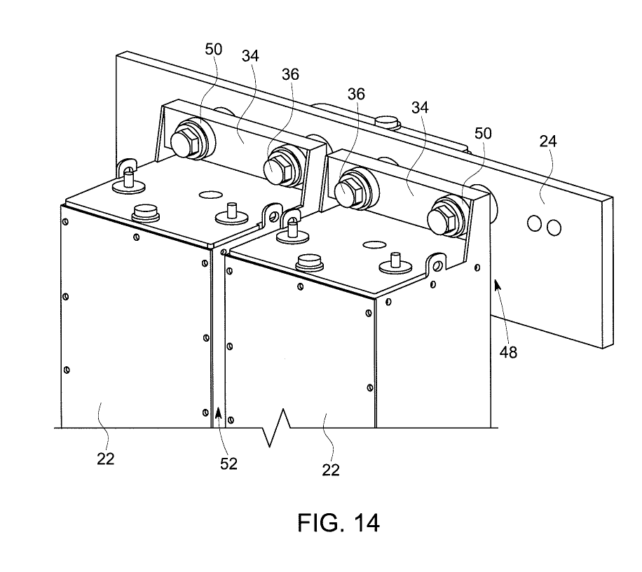

Referring now to FIGS. 10-14, installation and mounting of the modules 22, 28 within the housing 20 are illustrated. As shown in FIG. 10, the housing 20 also includes a plurality of steel mounting pins in the form of protrusions 46 that are welded to the bottom surface of the housing 20 and project upwardly therefrom. The protrusions 46 correspond in size and shape to the recess 44 within the mounting isolator 42 and socket mount 38. During installation, a battery module 22 (or battery module 28) is lowered vertically into the housing 20 in the direction of arrow A until the socket mount 38 (and mounting isolator 38) engages the mounting pin 46 such that the battery module is seated on the mounting pin, as shown in FIG. 11. In this position, the battery module 22 (or 28) is substantially restrained from lateral movement. Moreover, the elastomeric mounting isolator 42 provides for shock and vibration isolation and deflection during operation in demanding underground mine environments. As further shown in FIGS. 10 and 11, the pin 46 and socket mount 38 are positioned so as to define an air gap 48 between the modules 22, 28 and the partition walls 24 to which the modules are secured when the modules 22, 28 are seated on the pins 46.

In an embodiment, the socket mount 38 (and corresponding mounting isolator 42) and mounting pin 46 are substantially cylindrical in shape, although other configurations may be utilized without departing from the broader aspects of the present invention, such as rectangular, elliptical and the like. In an embodiment, one or both of the pin 46 and isolator 42 may have tapered (chamfered) features to facilitate self-alignment during the installation process. In addition, the material, stiffness and size of the isolator 42 may be chosen to achieve a desired amount of shock and vibration isolation and deflection. Typical isolation cutoff frequency (3 dB points) would range from 15 Hz to 100 Hz, depending upon the desired shock response, specific module design and stiffness, excitation forces imparted from the vehicle and/or battery housing. Typical isolator materials include silicone rubber.

While the embodiments described above and depicted in the figures show the socket 38 on the battery modules and the pin on the floor of the housing, such elements may also be reversed. For example, in an embodiment, each module may include a mounting pin on the bottom thereof configured to be received by a corresponding socket mount on the floor of the housing. Moreover, in an embodiment, a plurality of pins and sockets may be used to locate and retain each module in position (e.g., each module may have two socket mounts on the bottom thereof for mating with two pins on the floor of the housing). In yet other embodiments, each module may include both a pin and a socket extending from the bottom thereof configured to received/be received by a corresponding pin and socket on the floor of the housing.

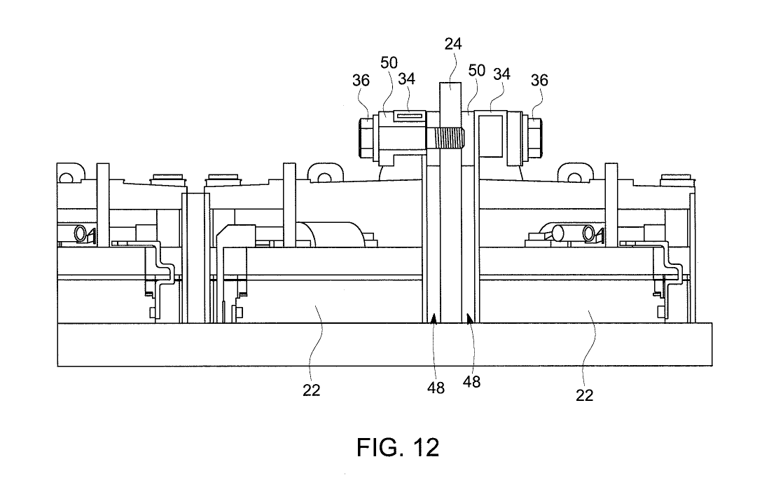

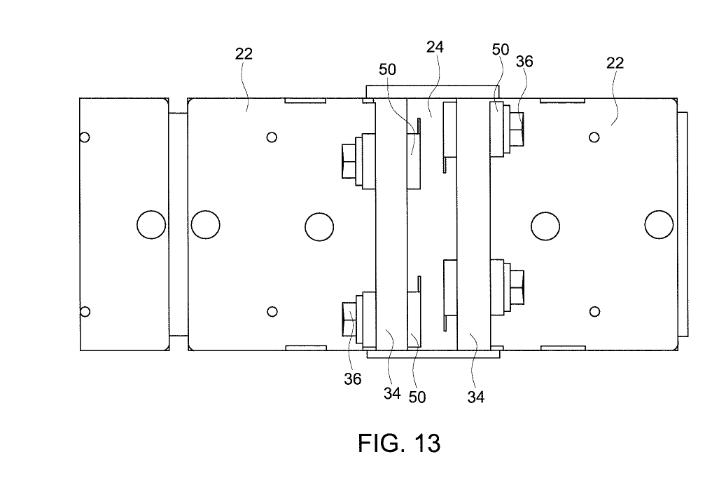

Turning now to FIGS. 12-14, once the module 22, 28 is seated on the mounting pin 46, the module 22, 28 is then bolted to the closest partition wall 24 or exterior wall of the tray 20. In particular, as shown therein, threaded shoulder bolts 36 are inserted through the apertures within the flange 34 of the battery module and received in corresponding threaded apertures formed in the partition wall 24. In an embodiment, two bolts are utilized to secure each module to a partition wall 24 or exterior wall, although more or fewer than two bolts may be utilized without departing from broader aspects of the present invention. As best shown in the top plan view of FIG. 13, the apertures in the flanges 34 and the corresponding mounting holes within the partition wall 24 are staggered (i.e., not symmetrically located on the flange 34) to enable opposing battery modules to be mounted to the same partition wall 24 back-to-back without interference. As also shown in FIGS. 12-14, in an embodiment, upper elastomeric isolators 50 may be utilized between the flange 34 and the partition wall 24 to further absorb vibration and shock.

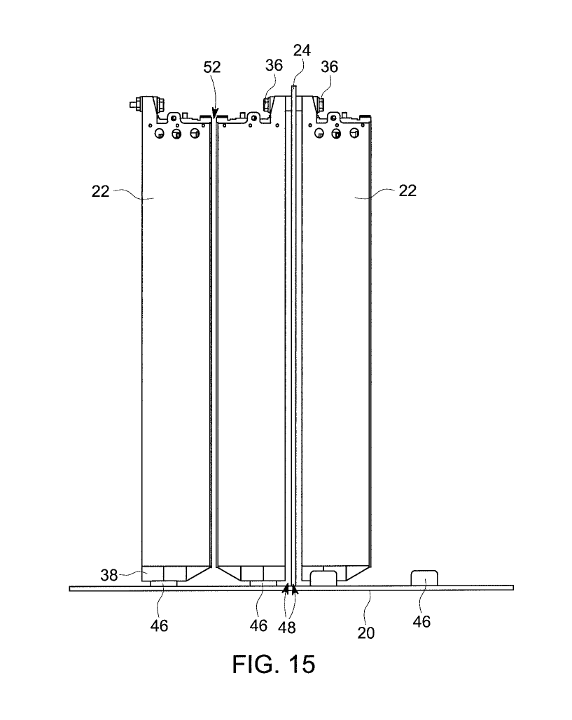

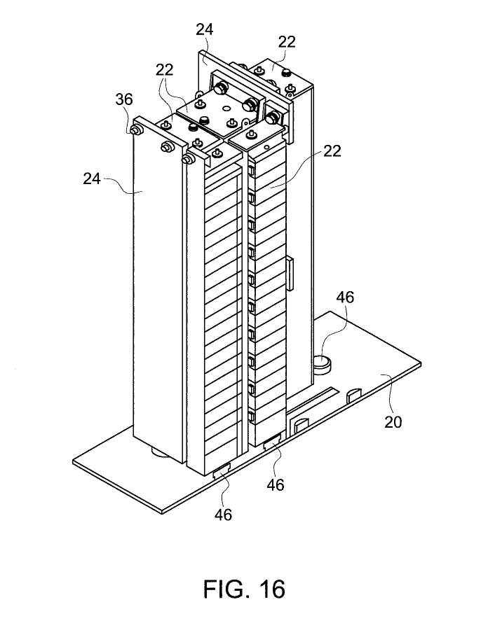

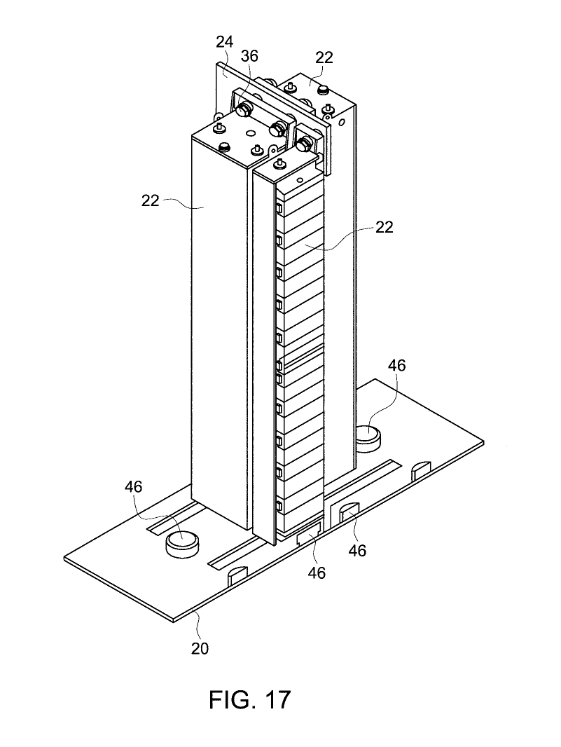

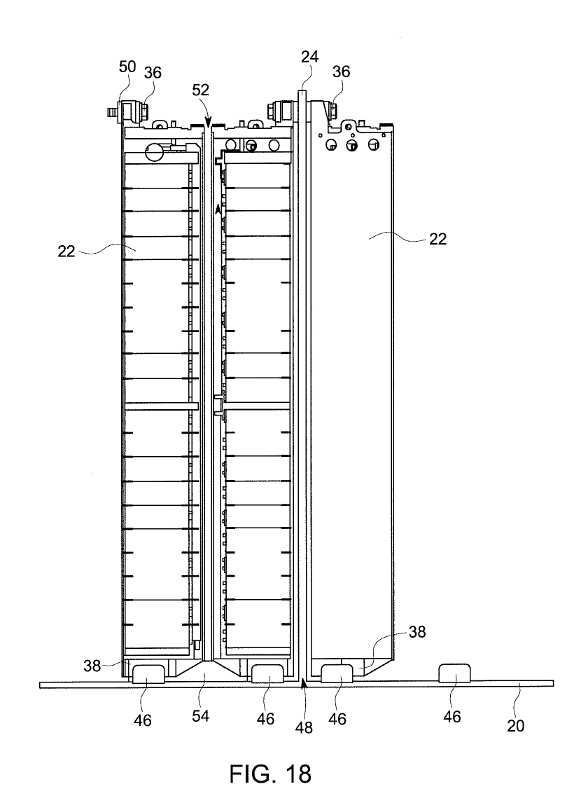

FIGS. 15-19 illustrate various detail views of battery modules 22 mounted to a partition wall 24 within the housing 20. As shown in FIGS. 15 and 18, the air gap 48 between the modules 22 and the partition wall 24, the air gap 52 between adjacent modules 22, and the air gap 54 between the bottom of the modules and the bottom floor of the housing 20 provide for natural convection. This flow of air through these gaps helps to automatically cool the battery modules arranged within the housing.

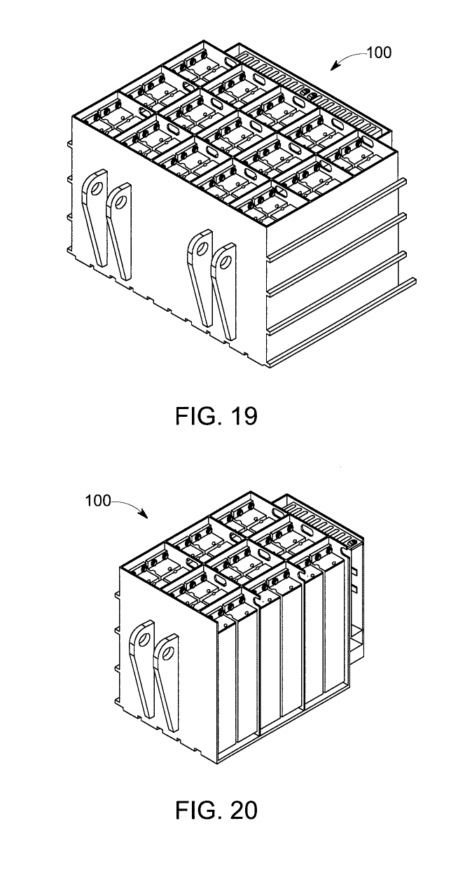

Referring finally to FIGS. 19 and 20, another embodiment of a battery packaging system 100 is illustrated, showing a housing containing 60 battery modules of the same size. The modules are mounted in substantially the same manner as discussed above in connection with battery packaging system 16. Indeed, the housing and interior partitions may be configured to allow for the vertical mounting of almost any number of battery modules therein, in any arrangement desired.

In connection with the embodiments described above, in operation, rechargeable battery modules 22, 28 may be installed in the tray/housing 20 by lowering each module into the tray from above via a hoist or other mechanism. The bottom pin 46 and socket 38 mate and seat each module in proper position within the tray 20. This pin/socket connection facilitates easy location and seating, which has heretofore been difficult because of the extremely limited access at the bottom of the tray. Once the module(s) are seated on their respective pin/socket connections, the top bolt mounts are bolted to the corresponding partition wall 24 or exterior tray wall. Electrical connections may then be made after all the modules are installed. Failed or depleted modules can be quickly exchanged for new (or recharged or refurbished) modules by simply opening/lifting the tray cover, electrically disconnecting the failed battery module, unbolting the module from the interior partition (or exterior tray wall, where applicable), and lifting out the module. As used herein, “failed” means a battery module that is not functioning as intended. A replacement module may then be lowered in, mounted and electrically connected, as described above. An advantage of this arrangement is that the modules can be installed and replaced effectively, independent of each other. For example, any individual module may be replaced without needing to remove other modules first, because of the vertical orientation of the modules in a single layer.

In an embodiment, the vertical orientation of the tall battery modules 22 is designed to match the housing/tray height (with the housing/tray height being generally further matched to the vehicle chassis height and operator visibility limitations). This enables a high fill factor in a wide range of housing dimensions and sizes, and corresponding high energy density, thereby allowing for more maneuverable vehicles that can operate for longer periods between charges. Moreover, the vertical orientation with accessible top mounting bolts, bottom pin/socket mounting, and the top electrical connections simultaneously enable the rapid installation and replacement of modules within the housing, the incorporation of shock and vibration isolation for longer life, and reduced manufacturing tolerances, resulting in lower cost. The vertical orientation of the modules also enables significant flexibility of the overall tray width and length to maximize the tray energy density for a wide range of vehicle sizes and models. The same modules can be used to create trays of a wide range of capacities and dimensions while maintaining high fill factors (i.e., space utilization).

In an embodiment, as system for a vehicle is provided. The system includes a housing connected to the vehicle, the housing having a bottom floor and a plurality of exterior walls, at least one partition wall within the housing dividing the housing into a plurality of sections, and a plurality of battery modules arranged in a vertical orientation within the housing. In an embodiment, the vehicle is an underground mining vehicle that includes a front portion having a work member and a rear portion including the housing, the front portion and the rear portion being connected via an articulated joint. In an embodiment, the housing includes one of a plurality of locating pins or sockets protruding upwardly from the bottom floor of the housing, the pins or sockets configured to seat each respective battery module in position within the housing. In an embodiment, each of the battery modules includes a respective battery module housing having a top end and a bottom end, a mounting flange extending upwardly from the top end, and the other of a socket or locating pin at the bottom end, and wherein the locating pin or socket of each battery module receives a corresponding one of the locating pins or sockets to seat each respective battery module in position within the housing. In an embodiment, each of the battery modules includes a plurality of electrical terminals at the top end for electrical interconnection among the battery modules. In an embodiment, each of the battery modules is mounted to at least one of the exterior walls of the housing and one of the at least one partition wall via a respective pair of threaded bolts. In an embodiment, the mounting flange of each of the battery modules respectively includes a pair of apertures for receiving the pair of bolts therethrough, the apertures being asymmetrically located on the mounting flange for the battery modules to be mounted back to back on opposing sides of the at least one partition wall. In an embodiment, a respective first elastomeric isolation element disposed in each socket. In an embodiment, for each of at least some of the battery modules, a respective second elastomeric isolation element is positioned between the mounting flange and one of the at least one partition wall. In an embodiment, the system includes an air gap located between each battery module and the exterior wall or partition wall to which each battery module is mounted. In an embodiment, the plurality of battery modules include at least a first battery module having a first height and a second battery module having a second height, the first height being greater than the second height. In an embodiment, the bottom floor of the housing includes an angled portion above which the second battery is positioned. In an embodiment, the first height of the first battery module corresponds to at least one of a height of the housing or a height of a frame of the vehicle. In an embodiment, the vehicle is a load-haul-dump vehicle and the battery modules are rechargeable lithium-ion battery modules. In an embodiment, the vehicle is an underground mining vehicle, the housing includes a plurality of locating pins protruding upwardly from the bottom floor of the housing, each of the battery modules includes a battery module housing having a top end and a bottom end, a mounting flange extending upwardly from the top end, and a socket at the bottom end, the socket of each battery module receives a corresponding one of the locating pins therein to seat each respective battery module in position within the housing, and the system further comprises a respective first elastomeric isolation element disposed in each socket. In an embodiment, each of the battery modules is mounted to at least one of the exterior walls of the housing or one of the at least one partition wall via a respective pair of threaded bolts, and the mounting flange of each of the battery modules respectively includes a pair of apertures for receiving the pair of bolts therethrough, the apertures being asymmetrically located on the mounting flange for the battery modules to be mounted back to back on opposing sides of the at least one partition wall. In an embodiment, the plurality of battery modules includes plural first battery modules each having a first height and plural second battery modules each having a second height, the first height being greater than the second height.

In an embodiment, an underground mining vehicle is provided. The vehicle includes a front section having a work member, a rear section having a battery packaging assembly for providing electrical power to the vehicle, and an articulated joint between the front section and the rear section. The battery packaging assembly includes a housing having a bottom floor, a plurality of exterior walls, at least one partition wall within the housing dividing the housing into a plurality of sections, and a plurality of battery modules within the housing, wherein each of the battery modules is elongate and the battery modules are arranged in the housing in a vertical orientation. The housing includes a plurality of locating pins protruding upwardly from the bottom floor of the housing. Each of the battery modules includes a battery module housing having a top end and a bottom end, a mounting flange extending upwardly from the top end, and a socket at the bottom end. The socket of each battery module receives a corresponding one of the locating pins therein to seat each respective battery module in position within the housing. The system further comprises a respective first elastomeric isolation element disposed in each socket, and the plurality of battery modules includes plural first battery modules each having a first height and plural second battery modules each having a second height, the first height being greater than the second height.

In an embodiment, an underground mining vehicle includes a front section having a work member, a rear section having a battery packaging assembly for providing electrical power to the vehicle, and an articulated joint between the front section and the rear section. The battery packaging assembly includes a housing having a bottom floor, a plurality of exterior walls, at least one partition wall within the housing dividing the housing into a plurality of sections, and a plurality of battery modules arranged in a vertical orientation within the housing. In an embodiment, the housing includes a plurality of locating pins protruding upwardly from the bottom floor of the housing. In an embodiment, each of the battery modules includes a respective battery module housing having a top end and a bottom end, a mounting flange extending upwardly from the top end, and a socket at the bottom end, and the socket of each battery module receives a corresponding one of the locating pins therein to seat each respective battery module in position within the housing. In an embodiment, each of the battery modules includes a respective plurality of electrical terminals at the top end for electrical interconnection among the battery modules. In an embodiment, each of the battery modules is mounted to at least one exterior wall of the housing or one of the at least one partition wall via a respective pair of threaded bolts. In an embodiment, the mounting flange includes a pair of apertures for receiving the pair of bolts therethrough, the apertures being asymmetrically located on the mounting flange for the battery modules to be mounted back to back on opposing sides of the at least one partition wall. In an embodiment, a respective first elastomeric isolation element is disposed in each socket. In an embodiment, the plurality of battery modules include at least a first battery module having a first height and a second battery module having a second height, the first height being greater than the second height. In an embodiment, the bottom floor of the housing includes an angled portion above which the second battery is positioned. In an embodiment, the first height of the first battery module corresponds to at least one of a height of the housing or a height of a frame of the vehicle.

In an embodiment, a method for installing a battery module in a vehicle is provided. The method includes lowering the battery module into a tray of the vehicle, the tray having at least one partition wall dividing the tray into a plurality of sections and a plurality of locating pins extending upwardly from a bottom of the tray, receiving one of the locating pins in a socket formed on the bottom of the battery module, and mounting an upper end of the battery module to the at least one partition wall. In an embodiment, the method also includes establishing an electrical connection between the battery module and at least one other battery module. In an embodiment, the method includes, prior to lowering the battery module into the tray, electrically disconnecting a failed battery module, unbolting the failed battery module from the at least one partition wall, and lifting the failed battery module from the tray. In an embodiment, the socket includes an elastomeric isolation element. In an embodiment, the locating pins and the socket are positioned so as to establish an air gap between the battery module and the at least one partition wall when the battery module is received on one of the locating pins.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §122, sixth paragraph, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods, without departing from the spirit and scope of the invention herein involved, it is intended that all of the subject matter of the above description or shown in the accompanying drawings shall be interpreted merely as examples illustrating the inventive concept herein and shall not be construed as limiting the invention.

1. A system for a vehicle, comprising:
a housing connected to the vehicle, the housing having a bottom floor and a plurality of exterior walls;
at least one partition wall within the housing dividing the housing into a plurality of sections; and
a plurality of battery modules arranged within the housing;
wherein the battery modules are elongate and have a height, defined by a longest axis of the battery modules, that is greater than a width or length the battery modules; and
wherein the battery module are arranged in a vertical orientation within the housing such that the longest axis of the battery modules is generally perpendicular to a ground surface on which the vehicle travels.

2. The system of claim 1, wherein:
the vehicle is an underground mining vehicle that includes a front portion having a work member and a rear portion including the housing, the front portion and the rear portion being connected via an articulated joint.

3. The system of claim 1, wherein:
the housing includes one of a plurality of locating pins or sockets protruding upwardly from the bottom floor of the housing, the pins or sockets configured to seat each respective battery module in position within the housing.

4. The system of claim 3, wherein:
each of the battery modules includes a respective battery module housing having a top end and a bottom end, a mounting flange extending upwardly from the top end, and the other of a socket or locating pin at the bottom end; and
wherein the locating pin or socket of each battery module receives a corresponding one of the locating pins or sockets to seat each respective battery module in position within the housing.

5. The system of claim 4, wherein:
each of the battery modules includes a plurality of electrical terminals at the top end for electrical interconnection among the battery modules.

6. The system of claim 4, wherein:
each of the battery modules is mounted to at least one of the exterior walls of the housing and one of the at least one partition wall via a respective pair of threaded bolts.

7. The system of claim 6, wherein:
the mounting flange of each of the battery modules respectively includes a pair of apertures for receiving the pair of bolts therethrough, the apertures being asymmetrically located on the mounting flange for the battery modules to be mounted back to back on opposing sides of the at least one partition wall.

8. The system of claim 4, further comprising:
a respective first elastomeric isolation element disposed in each socket.

9. The system of claim 8, further comprising:
for each of at least some of the battery modules, a respective second elastomeric isolation element positioned between the mounting flange and one of the at least one partition wall.

10. The system of claim 9, further comprising:
an air gap located between each battery module and the exterior wall or partition wall to which each battery module is mounted.

11. The system of claim 1, wherein:
the plurality of battery modules include at least a first battery module having a first height and a second battery module having a second height, the first height being greater than the second height.

12. The system of claim 11, wherein:
the bottom floor of the housing includes an angled portion above which the second battery is positioned.

13. The system of claim 11, wherein:
the first height of the first battery module corresponds to at least one of a height of the housing or a height of a frame of the vehicle.

14. The system of claim 1, wherein:
the vehicle is a load-haul-dump vehicle; and
the battery modules are rechargeable lithium-ion battery modules.

15. The system of claim 1, wherein:
the vehicle is an underground mining vehicle;
the housing includes a plurality of locating pins protruding upwardly from the bottom floor of the housing;
each of the battery modules includes a battery module housing having a top end and a bottom end, a mounting flange extending upwardly from the top end, and a socket at the bottom end;
the socket of each battery module receives a corresponding one of the locating pins therein to seat each respective battery module in position within the housing; and
the system further comprises a respective first elastomeric isolation element disposed in each socket.

16. The system of claim 15, wherein:
each of the battery modules is mounted to at least one of the exterior walls of the housing or one of the at least one partition wall via a respective pair of threaded bolts; and
the mounting flange of each of the battery modules respectively includes a pair of apertures for receiving the pair of bolts therethrough, the apertures being asymmetrically located on the mounting flange for the battery modules to be mounted back to back on opposing sides of the at least one partition wall.

17. The system of claim 15, wherein:
the plurality of battery modules includes plural first battery modules each having a first height and plural second battery modules each having a second height, the first height being greater than the second height.

18. An underground mining vehicle comprising:
a front section having a work member;
a rear section having a battery packaging assembly for providing electrical power to the vehicle; and
an articulated joint between the front section and the rear section; wherein:
the battery packaging assembly includes a housing having a bottom floor, a plurality of exterior walls, at least one partition wall within the housing dividing the housing into a plurality of sections, and a plurality of battery modules within the housing, wherein each of the battery modules is elongate, having a height defined by a longest axis of the battery modules, that is greater than a width or length the battery modules, and the battery modules are arranged in the housing in a vertical orientation such that the longest axis of the battery modules is generally perpendicular to a ground surface on which the vehicle travels;
the housing includes a plurality of locating pins protruding upwardly from the bottom floor of the housing;
each of the battery modules includes a battery module housing having a top end and a bottom end, a mounting flange extending upwardly from the top end, and a socket at the bottom end;
the socket of each battery module receives a corresponding one of the locating pins therein to seat each respective battery module in position within the housing;
the system further comprises a respective first elastomeric isolation element disposed in each socket; and
the plurality of battery modules includes plural first battery modules each having a first height and plural second battery modules each having a second height, the first height being greater than the second height.

19. An underground mining vehicle, comprising:
a front section having a work member;
a rear section having a battery packaging assembly for providing electrical power to the vehicle; and
an articulated joint between the front section and the rear section;
wherein the battery packaging assembly includes a housing having a bottom floor, a plurality of exterior walls, at least one partition wall within the housing dividing the housing into a plurality of sections, and a plurality of battery modules arranged within the housing;
wherein the battery modules are elongate and have a height, defined by a longest axis of the battery modules, that is greater than a width or length the battery modules; and
wherein the battery module are arranged in a vertical orientation within the housing such that the longest axis of the battery modules is generally perpendicular to a ground surface on which the vehicle travels.

20. The underground mining vehicle of claim 19, wherein:
the housing includes a plurality of locating pins protruding upwardly from the bottom floor of the housing.

21. The underground mining vehicle of claim 20, wherein:
each of the battery modules includes a respective battery module housing having a top end and a bottom end, a mounting flange extending upwardly from the top end, and a socket at the bottom end; and
wherein the socket of each battery module receives a corresponding one of the locating pins therein to seat each respective battery module in position within the housing.

22. The underground mining vehicle of claim 19, wherein:
each of the battery modules includes a respective plurality of electrical terminals at the top end for electrical interconnection among the battery modules.

23. The underground mining vehicle of claim 19, wherein:
each of the battery modules is mounted to at least one exterior wall of the housing or one of the at least one partition wall via a respective pair of threaded bolts.

24. The underground mining vehicle of claim 23, wherein:
the mounting flange includes a pair of apertures for receiving the pair of bolts therethrough, the apertures being asymmetrically located on the mounting flange for the battery modules to be mounted back to back on opposing sides of the at least one partition wall.

25. The underground mining vehicle of claim 21, further comprising:
a respective first elastomeric isolation element disposed in each socket.

26. The undergoing mining vehicle of claim 19, wherein:
the plurality of battery modules include at least a first battery module having a first height and a second battery module having a second height, the first height being greater than the second height.

27. The underground mining vehicle of claim 26, wherein:
the bottom floor of the housing includes an angled portion above which the second battery is positioned.

28. The underground mining vehicle of claim 26, wherein:
the first height of the first battery module corresponds to at least one of a height of the housing or a height of a frame of the vehicle.

29. A method for installing a battery module in a vehicle, comprising:
orienting the battery module so that a longest axis of the battery module is generally perpendicular to a ground surface on which the vehicle travels;
lowering the battery module into a tray of the vehicle, the tray having at least one partition wall dividing the tray into a plurality of sections and a plurality of locating pins extending upwardly from a bottom of the tray;
receiving one of the locating pins in a socket formed on the bottom of the battery module; and
mounting an upper end of the battery module to the at least one partition wall.

30. The method according to claim 29, further comprising the step of:
establishing an electrical connection between the battery module and at least one other battery module.

31. The method according to claim 30, further comprising the step of:
prior to lowering the battery module into the tray, electrically disconnecting a failed battery module, unbolting the failed battery module from the at least one partition wall, and lifting the failed battery module from the tray.

32. The method according to claim 29, wherein:
the socket includes an elastomeric isolation element.

33. The method according to claim 29, wherein:
the locating pins and the socket are positioned so as to establish an air gap between the battery module and the at least one partition wall when the battery module is received on one of the locating pins.
